(19) United States
(12) Patent Application Publication
(10) Pub. No.: US 2016/0095322 A1
(43) Pub. Date: Apr. 7, 2016

(54) METHOD FOR INCREASING THE SHELF LIFE OF PERISHABLE GOODS

(71) Applicant: REALCO S.A., Louvain-la-neuve (BE)

(72) Inventors: Sébastien Fastrez, Mons (BE); Gordon Blackman, Lasne (BE)

(73) Assignee: Realco S.A., Louvain-la-Neuve (BE)

(21) Appl. No.: 14/892,168

(22) PCT Filed: May 22, 2014
(86) PCT No.: PCT/EP2014/060511

§ 371 Date: Nov. 18, 2015

(30) Foreign Application Priority Data
May 22, 2013 (BE) 2013/0355

(51) Int. Cl. A01N 63/00; C11D 3/386

(52) U.S. Cl. CPC A01N 63/00; C11D 3/38654; C11D 3/386

(57) ABSTRACT

The invention relates to a method for increasing the shelf life of perishable goods, comprising the following steps: production of said perishable good in a production facility; delivery of said produced perishable product by means of a conveyor facility; packaging of said thus delivered perishable product by means of a packaging facility; and cleaning of at least one of the facilities selected from the group comprising the production facilities, the conveying facilities and the packaging facilities.

The present invention relates to a method for increasing the shelf life of perishable goods comprising the following steps:
producing said perishable good in a production facility,
delivering, by means of a conveyer facility, said produced perishable good,
packaging said thereby delivered perishable product by means of a packaging facility,
cleaning up at least one of the facilities selected from the group consisting of production facilities, conveyer facilities and packaging facilities.

A biofilm is a viscous film which develops on all surfaces, subsequent to the adhesion of microorganisms on these surfaces and to the secretion by the latter of polymers which cover them and facilitate their adhesion. Biofilms thus form a protective layer around microorganisms and represent a recurrent source of contamination in many environments, for example in water circuits, cooling towers, on all immersed equipment (boat hull, . . . ), in production facilities for perishable goods, for example producing foodstuffs which, because of their nature and of the deposits which they cause, generate a surrounding medium (or substrate) particularly favorable for the setting into place and development of biofilms.

Biofilms result from the accumulation of the polymers secreted by the bacteria (mainly proteins and polysaccharides), which generate a matrix which protects these microorganisms from outer aggressions and which has very strong resistance to conventional cleaning and disinfection procedures. Consequently, biofilms form a critical contamination source since they are present everywhere, thereby representing a high risk of contamination since they are very difficult to remove.

Unfortunately it is observed that this matrix is highly resistant and may form a barrier protecting the bacteria from the agents which would act against the microorganisms. Conventional treatments based on soda and/or including different biocides do not act in a sufficiently efficient way since they do not penetrate the biofilm in all of its thickness or are impregnated with certain molecules making up this matrix. The treatment is then only partly efficient on the upper surface of the biofilm.

Now, today, hygiene has become a problem of primary importance in agri-food industries. Indeed, contamination problems are increasing while the disinfection means used are increasingly powerful. Moreover, this problem should be tackled through a global approach, notably as regards the resistance phenomenon.

In the field of agri-food industries, the problem of the presence of biofilms is multiple. Firstly, the latter represent a permanent contamination source and are very difficult to remove with conventional means, even the most aggressive. Indeed, conventional disinfectants are inefficient since they do not manage to reach the microorganisms which are protected by the biofilm. Their incomplete removal causes and accelerates transfers of contamination.

Secondly, a biofilm is mixed. That is to say that, developed by certain strains, a biofilm may harbor other strains which live, develop and then cohabit as colonies (microbial consortium). These colonies promote communication between bacteria (communication via chemical mediators) but also exchange of genes. Propagation of the resistance genes borne by certain bacteria is thus facilitated within biofilms which are then even more difficult to remove. On this matter, facilities of food industries form an environment particularly favorable for these gene exchanges since many bacteria cohabit therein, for example in/on working surfaces, in refrigerators but also on production tools (rasps, knives, milling machines, . . . ). In biofilms, the problem is more enhanced because these strains are not even attained by the disinfectants protected by the matrix of the biofilm.

Further, in agri-food industries, at each production step, the quality of the food products may be deteriorated by the production tools with which these products are in contact. Indeed, biofilms actually form a major contamination source in agri-food industries, since they develop both on open surfaces (working surface, cutting tools, . . . ) and on closed surfaces (piping, heat exchangers, membrane facilities, . . . ), which multiplies the risks of contamination, of reduction in the quality of the products, of irregular and uncontrollable contaminations (recall of products, sanitary risks, . . . ), of reduction of productivity and reduction in the performance of the production tools (clogging, (bio-) corrosion of surfaces, . . . ).

Presently, it is not uncommon that industrialists are confronted with contaminations of foodstuffs because of the presence of biofilms, notably on the production tools. Even if biofilms form a protective layer for the microorganisms, impacts or friction may ensure that strips of biofilms may be detached and release bacteria which were accommodated therein, for example subsequent to an impact or to friction from a production tool, for example a knife on a working surface or subsequent to the friction of an actual food product against a production tool or a working surface, which allows free transfer of bacteria.

This problem is one of the causes of rapid deterioration of food products which are contaminated before their packing, by microorganisms which degrade them rapidly. The result of this is that food products, even if they are packaged and conditioned under a controlled atmosphere deteriorate even if they are preserved under optimum conditions, for example in the refrigerator.

Such contaminations due to bacteria released initially from biofilms, in addition to the fact that they considerably reduce the shelf life of food products, may even lead to destruction of the batch of foodstuffs, or even to a deterioration of the production tools which may be clogged by the presence of biofilms.

Unfortunately, even if the presence of biofilms within agri-food industries represents a standard problem, the conventional cleaning and disinfection techniques presently applied show certain limits as to the removal of biofilms, in particular for increasing the shelf life of perishable foodstuffs. This is mainly related to the inadequacy of present cleaning techniques for attacking the matrix of the polymers which protect the microorganisms. Indeed, “conventional” detergents do not give the possibility of detaching this matrix and powerful oxidizers only dissolve it partially. The disinfectants and/or biocides used a posteriori are consequently inefficient since they cannot attain the microorganisms. Further, it was demonstrated that the bacteria secrete substances which have an impact on the efficiency of the biocides, which limits even more the action of the latter.

Presently, it is therefore particularly difficult to remove the bacteria as well as the biofilms however greatly responsible for rapid degradation of perishable goods. Present cleaning procedures but also all the precautionary measures applied, such as for example the wearing of gloves, of a protective bonnet or of an apron, actually prove to be insufficient even if a bacterial contamination tolerance threshold is tolerated in agri-food industries. However, exponential growths of bacterial colonies impose that this threshold be strictly observed and not exceeded, otherwise too consequent contaminations may compromise the whole production line of perishable goods. This is why there exists a real need for reinforcing the fight against the presence of bacteria and of biofilms in order to increase the shelf life of perishable goods. More particularly, therefore there exists a real need for developing a composition and a method for removing biofilms from surfaces such as for example those of production facilities of perishable goods in order to increase the shelf life of the perishable goods since present cleaning techniques and precautionary measures are not sufficiently efficient.

By the term of <<shelf life>> in the sense of the present invention is meant the period during which the preservation of a product under reasonably predictable conditions does not allow sufficient microbial proliferation for inducing exceedance of the acceptable criteria for the whole of the germs. Presently, no universal method exists for determining the shelf life or the best-before date (BBD). Nevertheless, within the scope of the present invention, the shelf life is determined according to the AFNOR standard (NF 01-003).

The object of the invention is to overcome these drawbacks by providing a method as indicated in the beginning, characterized in that said cleaning step comprises at least one step for removing biofilms by a surface treatment for a predetermined time period with a composition comprising at least one detergent component and at least one enzymatic component and a step for rinsing and/or drying said surface.

Advantageously, according to the invention, said detergent component comprises a wetting agent and a dispersant.

Preferably, according to the invention, said detergent component further comprises a sequestering agent.

Preferentially, according to the invention, said at least one enzymatic component for example contains at least one protease, at least one laccase and at least one polysaccharidase.

Within the scope of the present invention, it was shown that following detection of the presence of a biofilm, for example by means of a detection kit as described in document EP 2 537 601, such a treatment with such a composition according to the invention gives the possibility to enzymes (proteases, laccases, polysaccharidases) of efficiently degrading and in a comprehensive way, organic polymers of different natures making up the matrix of the biofilms formed by a multitude of different microorganisms directly or indirectly responsible for rapid degradation of perishable goods, which considerably reduces the shelf life thereof.

Under the action of enzymes and together with the action of the detergent component, the matrix of the biofilm is weakened and swollen, which gives the possibility of removing it from the treated surface. Moreover, surprisingly, it was also shown that the method according to the invention is not specific to a particular microorganism and therefore to a type of particular biofilm but is suitable for many bacterial strains, the enzymes acting on the polymers of the matrices of the biofilms formed by any microorganism.

The detergent action of the composition according to the invention further gives the possibility of ensuring the efficiency of the composition according to the invention. For this purpose, according to the invention a detergent base is provided, which is compatible and which may synergistically act with the enzymatic activity of the enzymatic component. Further, according to the invention, a detergent base is provided which gives the possibility of significantly improving the rapidity and the efficiency for removing the biofilm. This is why the present invention associates a wetting agent and a dispersant and optionally a sequestering agent. The joint actions of these agents of the detergent component of the composition according to the invention allows removal of the surface portion of the biofilm, wetting and swelling of the organic structures of the biofilm therefore in this way promoting accessibility of the enzymatic component which weakens and degrades in turn the matrix of the biofilm.

Quite unexpectedly, it was determined within the scope of the present invention that such a treatment efficiently acts on the microorganisms responsible for the degradation of perishable goods. Contrary to expectation, it was shown that the treatment according to the invention not only allows removal of the biofilms but also very significant limitation of the proliferation of the bacteria inherent to the perishable goods. Indeed, following the removal of the biofilms, it was determined, within the scope of the present invention that the presence of bacteria specific to the foodstuffs (and therefore not protected by a biofilm) is also reduced consequently, which widely contributes to increasing the shelf life of the foodstuffs. In fact, it was shown that the biofilms essentially consisting of polysaccharides and of proteins form a preferred nutritive substrate particularly suitable for the bacteria inherent to perishable goods, a removal of the biofilms therefore contributing to significant limitation in the development and proliferation of bacteria inherent to food products such as for example salmonellae.

By removing the substrate formed by the biofilms it is therefore possible to strongly reduce the presence of these bacteria from the actual perishable goods. Therefore, a cleaner environment with clearly less contaminants is obtained according to the method of the present invention, which gives the possibility of considerably increasing the shelf life of perishable goods. Actually, clearly and significantly superior results are obtained in terms of removal of the biofilms and of the bacteria inherent to the perishable goods, and therefore in terms of increase in the shelf life of perishable goods are obtained as compared with the presently applied treatment techniques in agri-food media.

Preferably, in accordance with the method according to the invention, said surface treatment step for increasing the shelf life of perishable goods comprises a step for removing the biofilms giving the possibility of increasing the shelf life of perishable goods by at least 5%, preferably by at least 10%, preferentially by at least 20%. According to the invention, the shelf life may be increased up to 50%, preferably up to 60%, preferentially up to 75%.

Preferably, in accordance with the method according to the invention, said surface treatment step is carried out by applying, for a predetermined time period comprised between 1 minute and 1 hour, preferably comprised between 3 minutes and 30 minutes, a solution comprising said composition and an aqueous dilution phase formed beforehand. Such a treatment is particularly indicated for cleaning surfaces or production tools (rasps, knives, milling machines, . . . ).

Advantageously, according to the invention, said surface treatment step is associated with a step for mechanical abrasion of said surface, for example by mechanized or manual brushing or further by applying medium or high pressure rinsing. An additional mechanical abrasion step gives the possibility to the solution comprising said composition in an aqueous phase of acting on the various layers of the biofilms but also mechanically participating in the destructuration of the polymeric matrix and thus removing strips from the surface of the biofilms so that the enzymes and the other components of said composition even better attain the various layers of the biofilms, which ensures optimum treatment of the surfaces in order to efficiently remove the biofilms.

Preferably, in accordance with the method according to the invention, the pH of said solution is adjusted to a pH value comprised between 7 and 8.

Preferably, according to the invention, the method further comprises a subsequent additional step for treating said surface with a biocide. An additional disinfecting biocidal treatment, following the action of the enzymatic solution during the surface treatment step by soaking, gives the possibility of ensuring destruction of the released bacteria at the end of the treatment of said surface.

Other embodiments of the method according to the invention are indicated in the appended claims.

The present invention also deals with a novel use of a composition comprising at least one detergent component and at least one enzymatic component, in order to increase the shelf life of perishable goods by removing biofilms. By removing the biofilms by applying the diluted composition it is possible to efficiently control the bacteria responsible for the degradation of perishable goods since the enzymatic components of the aqueous solution allow destructuration and removal of the biofilms from the treated surfaces so that the biofilms, greatly responsible for the degradation of perishable goods, are removed.

This action of the enzymes is promoted by the fact that it occurs synergistically with the action of the detergent component of the composition according to the invention, which allows removal of the surface portion of the biofilm, wetting and swelling of the organic structures of the biofilm and thereby promoting accessibility of the enzymatic component which weakens and degrades in turn the matrix of the biofilm.

Preferably, according to the invention, said detergent component of the composition used comprises a wetting agent and a dispersant.

Advantageously, according to the invention, said detergent component of the composition used further comprises a sequestering agent.

Preferably, according to the invention, said enzymatic component of the composition used for example contains at least one protease, at least one laccase and at least one polysaccharidase.

More particularly, the present invention deals with a use of a composition comprising at least one detergent component comprising a wetting agent and a dispersant and optionally a sequestering agent, and at least one enzymatic component containing at least one protease, at least one laccase and at least one polysaccharidase, for removing contamination sources comprising Listeria monocytogenes and/or Bacillus cereus and/or Bacillus mycoides and/or Pseudomonas aeruginosa and/or Pseudomonas fluorescens. These bacteria developed particularly well in media found in agri-food industries and significantly promote the degradation of perishable goods which, consequently can only be preserved for a short lapse of time.

The invention also deals with a use of a composition comprising at least one detergent component and at least one enzymatic component, for treating surfaces, production tools, conveyer and/or production and/or packaging facilities for increasing the shelf life of foodstuffs.

Preferably, said detergent component of said composition used comprises a wetting agent and a dispersant.

Advantageously, said detergent component of said composition used further comprising a sequestering agent.

Preferentially, said enzymatic component of said composition used for example contains at least one protease, at least one laccase and at least one polysaccharidase.

Other embodiments of the use of a composition by soaking according to the invention are indicated in the appended claims.

The detergent component comprising a wetting agent and a dispersant and optionally a sequestering agent first of all act by removing a surface portion of the biofilm and by wetting and/or swelling the organic structures of the biofilm.

The detergent component therefore promotes accessibility of the enzymatic component by destructuring the matrix of the biofilm. The enzymatic component then acts synergistically with the detergent component and weakens and degrades in turn the matrix of the biofilm. This combined action of the three types of enzyme and of the detergent component, perfectly compatible with proper action of the enzymes, promotes accessibility to the composition of deeper layers and allows rapid and optimal detachment of any type of biofilm while preserving the substrate. Such a composition according to the invention further reduces the provision of external compounds in facilities during the cleaning step and therefore simplifies the procedures for validating the cleaning steps. Thus, the detergent component allows the enzymes to rapidly act on the whole of the structures of the biofilms, which, in an agri-food medium where a rapid line production is applied, surely represents an advantage.

The dispersant of the detergent component gives the possibility of improving the separation of the particles of a suspension in order to prevent agglutination, aggregation and/or decantation. Said dispersant may be a soluble or partly soluble polymer in water such as for example polyethylene glycol, derivatives of cellulose or a polymer comprising at least one acrylic acid or acrylic ester unit. Preferentially, the dispersant agent is a polymer comprising at least one acrylic acid or acrylic ester unit of the general formula —(CH₂—CH—COOR)— wherein R represents a hydrogen, an alkyl or substituted alkyl group, an aryl or substituted aryl group. In particular, the dispersant is a polymer having an average molecular weight Mw approximately comprised between 500 and 10,000.

More preferentially, the dispersant is a polymer of acrylic acid. In particular, the dispersant may be a homopolymer of acrylic acid having an average molecular weight approximately comprised between 2,000 and 6,000.

In an advantageous alternative according to the invention, the detergent component comprises a proportion of dispersant comprised between 1 and 10% by weight based on the total weight of the detergent component.

More particularly, according to the present invention, said dispersant of said detergent component is the C₆ alkylglucoside.

The presence of a dispersant in the composition according to the invention for removing the biofilms and increasing the shelf life of perishable goods (for example foodstuffs) gives the possibility of avoiding any aggregation of bacterial particles during the cleaning of surfaces, which ensures optimum removal of the particles of biofilms detached from a support under the action of the enzymes. Indeed, rather than aggregate, these particles remain separate in a suspension, do not redeposit and do not again adhere onto the clean sub-support.

The wetting agent of the detergent component is an amphiphilic chemical substance, or a composition comprising said amphiphilic chemical substance, which modifies the surface tension between both surfaces. The wetting agent has the advantage of promoting the spreading of a liquid over a solid but also enhancing the contact between two surfaces. More particularly, the wetting agent promotes a contact between the detergent component and a surface and, consequently, between the enzymes and their substrate. Now, in agri-food industries, the surfaces to be treated are often in stainless steel or in a material on which the application of a liquid gives rise to the formation of droplets. This feature of the surfaces to be treated makes it difficult to homogeneously apply a composition in liquid form in order to fight against the presence of biofilms. This is why, the wetting agent is a particularly advantageous constituent of said composition according to the invention since it allows, even on surfaces of the stainless steel type, homogeneous spreading of the composition and thus its perfect distribution over the surfaces to be decontaminated, for example on the production tools, the working surfaces and the floors.

The wetting agent may be anionic, cationic, non-ionic or zwitterionic. Preferentially, the wetting agent may be an anionic or non-ionic wetting agent, i.e. the hydrophilic portion is negatively charged or does not include any neat charge, or may be a composition comprising an anionic wetting agent. More particularly, the wetting agent may be an ester of saccharose or a composition comprising a sodium alkyl sulfate and an alcohol.

The wetting agent may be a foaming or non-foaming agent. Preferably, in the detergent component according to the invention, said wetting agent is non-foaming under hot conditions and is preferably selected from the group of sodium C₆-C₁₀ alkyl sulfates, C₆-C₁₀ etherated alcohol sulfates and C₆-C₁₀ alkylaryl sulfonates.

More particularly, according to the present invention, said wetting agent of said detergent component is ethoxylated 2-ethylhexanol.

The fact that the foaming agent is non-foaming under hot conditions allows use of the composition according to the invention for treating production tools having tubes or pipes. Indeed, as the foaming agent is non-foaming, this gives the possibility of avoiding formation of foam, without altering, quite on the contrary, the surfactant and/or emulsifying performances of the composition according to the invention. It is quite understood that provision of an efficient detergent solution without generating any foam limits the rinsing steps, which is particularly desirable, especially for production tools having tubes which may thus be rapidly used again.

In an embodiment according to the invention, the detergent component comprises a wetting agent proportion comprised between 1 and 15% by weight based on the total weight of the detergent component.

The sequestering agent is a chemical substance having the capability of forming complexes with mineral ions which it binds in a form preventing their precipitation through customary reactions. As an example, the sequestering agent may be ethylene-diamine-tetraacetic acid, glucono-delta-lactone, sodium gluconate, potassium gluconate, calcium gluconate, citric acid, phosphoric acid, tartaric acid, sodium acetate, sorbitol, a compound including a phosphorus atom. Preferentially, the sequestering agent may be a phosphorus oxide such as a phosphonate, a phosphinate or a phosphate or mixture thereof, or a salt of the latter, an amine or an amine oxide bearing at least in its structure, a phosphine, phosphine oxide, phosphinite, phosphonite, phosphite, phosphonate, phosphinate or phosphate functional group either alone or as a combination, or a salt thereof.

Advantageously, the sequestering agent is a chemical substance compatible with food substances, for example the sequestering agent is preferentially a non-toxic agent for human health.

More preferentially, the sequestering agent may be a phosphonate or a salt thereof, an amine or an amine oxide including at least, in its structure, a phosphine, phosphine oxide, phosphinite, phosphonite, phosphite, phosphonate, phosphinate or phosphate functional group, either alone or as a combination, or a salt thereof. As a non-limiting example, the phosphonate may be of the general formula R¹(R²O)(R³O)P=O wherein R¹, R² and R³ independently represent a hydrogen, an alkyl, substituted alkyl, alkylamino group either substituted or not, an aminoalkyl group either substituted or not, an aryl or substituted aryl group. As a non-limiting example, the amine or the amine oxide may include one, two or three substituents of the general formula CR⁴R⁵W wherein R⁴ and R⁵ represent independently of each other a hydrogen, an alkyl, substituted alkyl, alkyl-amino group either substituted or not, an aminoalkyl group either substituted or not, an aryl or substituted aryl group, and W represents a phosphonate, phosphinate or phosphate group.

The sequestering agent may be in the form of a sodium, calcium, lithium, magnesium or potassium salt; preferentially the sequestering agent may be in the form of a sodium, calcium or potassium salt.

Preferably, the sequestering agent is an agent which may be used without any danger in the food sector, i.e. the sequestering agent has no risk for health, either alone or associated with other components.

More particularly, according to the invention, said sequestering agent of said detergent component is a potassium salt based on modified phosphonic acid (N-oxide ATMP).

In an advantageous embodiment according to the invention, said at least one detergent component comprises a proportion of sequestering agent comprised between 1 and 10% by weight based on the total weight of the detergent component, which represents an optimum between efficiency, stability and cost.

Preferably, said at least one enzymatic component comprises a proportion of protease(s) comprised between 10 and 50%, a proportion of laccase(s) comprised between 5 and 35% and a proportion of polysaccharidase(s) comprised between 5 and 20% by weight based on the total weight of the enzymatic component, the 100% of the enzymatic component being optionally attained by means of an excipient or a conventional solvent, for example an alcohol.

The enzymatic component according to the invention has the advantage of being multiple-purpose, i.e. it may act simultaneously on various bacterial strains, which is particularly advantageous in agri-food industries where many different bacterial strains develop simultaneously.

According to a preferred embodiment of the invention, the enzymatic component may contain between 1 and 10 proteases, preferentially between 1 and 5 proteases, more preferentially it may contain 2, 3, 4 or 5 proteases.

Non-limiting examples of protease enzymes belonging to the class EC 3.4 and which may be used in the invention are aminopeptidases (EC 3.4.11), dipeptidases (EC 3.4.13), dipeptidyl-peptidases and tripeptidyl-peptidases (EC 3.4.14), peptidyl-dipeptidases (EC 3.4.15), serine carboxypeptidases (EC 3.4.16), metallo-carboxypeptidases (EC 3.4.17), cysteine carboxypeptidases (EC 3.4.18), omega-peptidases (EC 3.4.19), serine endopeptidases (EC 3.4.21), cysteine endopeptidases (EC 3.4.22), aspartic endopeptidases (EC 3.4.23), metallo-endopeptidases (EC 3.4.24), threonine endopeptidases (EC 3.4.25), and endopeptidases belonging to the class EC 3.4.99.

Preferentially, the proteases belong to the class EC 3.4.21. Proteases are available commercially and in different forms including powders, granules, suspensions, liquid solutions.

The laccases used in the invention belong to the class EC 1.10.3.2. Laccases are enzymes containing copper and have the function of oxidizing a substrate in the presence of oxygen. More specifically, laccases are oxidoreductases which operate with molecular oxygen as an electron acceptor.

Said at least one polysaccharidase used in the invention is an enzyme having the function of breaking bonds within polysaccharides. Preferentially, said at least one polysaccharidase may be an alpha-amylase, cellulose, hemi-cellulose, glucosidase, beta-glucanase or pectinase.

More preferentially, said at least one polysaccharidase may be an alpha-amylase belonging to the class EC 3.2.1.1, having the function of breaking (1-4)-alpha-glycoside bonds in polysaccharides containing three units or more of alpha-(1-4)-D-glucose.

Preferentially, the enzymatic component may comprise a proportion of laccase(s) of approximately 30%, a proportion of protease(s) of approximately 30%, a proportion of alpha-amylase(s) of approximately 10% by weight based on the total weight of the enzymatic component, the 100% of the enzymatic component being optionally attained by means of a conventional excipient or solvent.

According to another preferred embodiment, if the enzymatic component comprises two proteases, the proportion of laccase(s) may be approximately 30%, the total proportion of proteases of approximately 30%, the proportion of alpha-amylase(s) of approximately 10% by weight based on the total weight of the enzymatic component, the 100% of the enzymatic component being optionally attained by means of a conventional excipient or solvent.

For example, the ratio between each protease may be comprised between 1:2 and 2:1, preferentially the ratio between each protease may be 1:1. The enzymes present in the enzymatic component have an additional action on the biofilm. For example, the laccase has great efficiency on stains which are not etched by alpha-amylase or proteases. As mentioned above, the enzymatic component, because of the simultaneous presence of at least three types of enzymes, is multipurpose and may act at the same time on various types of biofilms produced by diverse bacterial strains, which is essential in an agri-food medium.

According to a preferred embodiment of the invention, the enzymatic component may be a solution or in solid form.

Preferentially, the enzymatic component is a solution for which the pH may be approximately comprised between 8 and 10. Preferentially, the enzymatic component is an aqueous solution for which the pH may be approximately comprised between 8.5 and 9.5; more preferentially, the pH may be approximately 9.0, and this for at most preserving the integrity of the enzymes.

Alternatively, the enzymatic component may be in solid form such as for example as a lyophilizate, as powders, granules or in any other form allowing solubilization of said component in a solvent, and then it will subsequently be dissolved in said solvent. The solvent may be water or an aqueous, acid, basic, alcohol, buffered or neutral solution. The solubilized enzymatic component may then in this case be subsequently diluted in an aqueous solution optionally containing one or several compounds such as for example detergents for forming the cleaning solution.

Like for the enzymatic component, the detergent component may be in a solid form to be dissolved in a solvent and/or in an aqueous phase or in liquid form.

When it is in solid form, it may either be put directly in solution into the solution formed by the enzymatic component optionally already diluted in the aqueous phase, or be put in solution in a solvent, before its dilution in the solution formed by the enzymatic component and the aqueous phase, or directly in the aqueous phase, before dilution of the enzymatic component.

When the detergent component is in liquid form, the 100% of the detergent component are optionally attained generally with water and before application on the biofilm, it will be diluted in an aqueous phase, optionally containing already the enzymatic component.

Optionally, according to the method of the present invention, the pH of said solution is adjusted to a pH value comprised between 6.5 and 7.5, more particularly around 7.

Alternatively, said composition may be in solid form and then be dissolved before its use in a solvent in order to obtain, when it will be diluted in an aqueous phase before application on a biofilm, a solution for which the pH is approximately comprised between 7 and 8. In an advantageous alternative according to the invention, the composition is a solution provided for, when it is diluted in an aqueous phase before application on the biofilm, forming a solution having a pH approximately comprised between 6.5 and 7.5, more particularly of about 7. In this way, the pH of the solution of the composition is particularly suitable for the action of the enzymatic component, in particular the laccase.

Alternatively, said composition may be in solid form and then be dissolved before use in a solvent in order to obtain a solution which will then be diluted in an aqueous phase so as to obtain a cleaning solution for which the pH is approximately comprised between 6.5 and 7.5, preferably about 7.

According to the method of the present invention, the entirety of the matrix of the biofilms is removed, the surface treatment according to the invention only leaving “naked” bacteria, i.e. bacteria without any protection and which may thus be easily removed in totality upon a subsequent use of a biocide, as explained hereafter after rinsing the composition.

As mentioned above, the composition according to the invention comprises a detergent component which promotes the action of the enzymes by allowing them to rapidly attain the lower layers of the biofilms and not only their upper layer. The enzymes may therefore act very rapidly on the whole of the structure of the biofilms and thus expose all the bacteria not only at the surface of the biofilms but also at the lower layers which make them up.

It is quite understood that the present invention is by no means limited to the embodiments described above and that many modifications may be brought thereto without departing from the scope of the appended claims.

1. A method for increasing the shelf life of perishable goods comprising the following steps:
producing said perishable good in a production facility,
delivering with a conveyer facility, said produced perishable good,
packaging, with a packaging facility, said thereby delivered foodstuff,
cleaning at least one of the facilities selected from the group consisting of production facilities, conveyer facilities and packaging facilities,
wherein said cleaning step comprises at least one step for removing biofilms by surface treatment for a predetermined time period with a composition comprising at least one detergent component and at least one enzymatic component and a step for rinsing and/or drying said surface.

2. The method for increasing the shelf life of perishable goods according to claim 1, said detergent component comprising a wetting agent and a dispersant.

3. The method for increasing the shelf life of perishable goods according to claim 1, said detergent component further comprising a sequestering agent.

4. The method for increasing the shelf life of perishable goods according to claim 1, said at least one enzymatic component for example containing at least one protease, at least one laccase and at least one polysaccharidase.

5. The method for increasing the shelf life of perishable goods according to claim 1, wherein said surface treatment step for increasing the shelf life of perishable goods comprises a step for removing the biofilms giving the possibility of increasing the shelf life of perishable goods by at least 5%, preferably by at least 10%, preferentially by at least 20%.

6. The method according to claim 1, wherein said surface treatment step is carried out by applying, for a predetermined time period comprised between 1 minute and 1 hour, preferably comprised between 3 minutes and 30 minutes, a solution comprising said composition and a dilution aqueous phase formed beforehand.

7. The method for increasing the shelf life of perishable goods according to claim 1, wherein said surface treatment step is associated with a step for mechanical abrasion of said surface with said solution, for example by mechanized or manual brushing or further by applying medium or high pressure rinsing.

8. The method for increasing the shelf life of perishable goods according to claim 1, further comprising an additional step for treating said surface by means of a biocide.

9. A method for the use of a composition comprising at least one detergent component and at least one enzymatic component, comprising increasing a shelf life of perishable goods by removing biofilms.

10. The method for the use of a composition according to claim 9, said detergent component comprising a wetting agent and a dispersant.

11. The method for the use of a composition according to claim 9, said detergent component further comprising a sequestering agent.

12. The method for the use of a composition according to claim 9, said enzymatic component for example containing at least one protease, at least one laccase and at least one polysaccharidase.

13. The method for the use of a composition according to claim 9, comprising removing contamination sources comprising Listeria monocytogenes and/or Bacillus cereus and/or Bacillus mycoides and/or Pseudomonas aeruginosa and/or Pseudomonas fluorescens.

14. A method for the use of a composition comprising at least one detergent component and at least one enzymatic component, comprising treating surfaces, production tools for perishable goods or conveying and/or production facilities and/or packaging facilities and increasing a shelf life of perishable goods.

15. The method for the use of a composition according to claim 14, said detergent component comprising a wetting agent and a dispersant.

16. The method for the use of a composition according to claim 14, said detergent component further comprising a sequestering agent.

17. The method for the use of a composition according to claim 14, said enzymatic component for example containing at least one protease, at least one laccase and at least one polysaccharidase.
